(19) United States
(12) Patent Application Publication
(10) Pub. No.: US 2024/0408727 A1
(43) Pub. Date: Dec. 12, 2024

(54) Engaging Structure for Hand Tool

(71) Applicant: Chia-Kuan Liao, Taichung City (TW)

(72) Inventor: Chia-Kuan Liao, Taichung City (TW)

(21) Appl. No.: 18/330,439

(22) Filed: Jun. 7, 2023

(51) Int. Cl. B25B 23/10

(52) U.S. Cl. CPC B25B 23/105; B25B 13/065; B25B 13/08; B25B 13/462

(57) ABSTRACT

An engaging structure includes a main body including a first side, a second side, a third side, and a fourth side. The first side, the third side, the fourth side, and the second side construct a hexagon. The hexagon has an axis, a fourth length, and a vertical line. The first side is provided with a first recess and a first face. The first recess is situated at a left side of the vertical line. The vertical line passes the first face. The first recess is provided with a first arcuate face and a second arcuate face. The second side is provided with a second recess and a second face. The second recess is situated at a left side of the vertical line. The vertical line passes the second face. The second recess is provided with a first corner and a second corner.

### BACKGROUND OF THE INVENTION

### Field of the Invention

The present invention relates to a hand tool and, more particularly, to an engaging structure for a hand tool.

### Description of the Related Art

A conventional socket structure was disclosed in the U.S. Publication No. 20060117917, and comprises a socket 20 provided with an engaging hole 22 including multiple grooves 23 and multiple stop ribs 24. When the engaging hole 22 of the socket 20 is mounted on a screw head 40, the stop ribs 24 are locked on the screw head 40 to drive and rotate the screw head 40.

However, such a conventional socket structure has the following disadvantages.
1. The stop ribs 24 engage the six sides of the screw head 40, but each of the stop ribs 24 has a sharp pointed shape so that when the screw head 40 is driven by the socket 20, the stop ribs 24 of the socket 20 easily wear and cause bite marks on the six sides of the screw head 40.
2. Each of the stop ribs 24 has a sharp pointed shape so that the stop ribs 24 have a less contact area with the six sides of the screw head 40, thereby decreasing the rotational torque of the stop ribs 24 applied on the screw head 40.

### BRIEF SUMMARY OF THE INVENTION

In accordance with the present invention, there is provided an engaging structure comprising a main body including a first side, a second side, a third side, and a fourth side. The first side, the third side, the fourth side, and the second side construct a hexagon. The hexagon has an axis, a fourth length, and a vertical line. The first side is provided with a first recess and a first face. The first recess is situated at a left side of the vertical line. The vertical line passes the first face. The first recess is provided with a first arcuate face and a second arcuate face. The second side is provided with a second recess and a second face. The second recess is situated at a left side of the vertical line. The vertical line passes the second face. The second recess is provided with a first corner and a second corner.

According to the primary advantages of the present invention, the main body includes the first recess, the first face, the second recess, and the second face. The first recess and the first face of the main body have a larger rotation face and provide a protection when the main body is rotated to tighten the screw member. In addition, the second recess of the main body engages the screw member, and the second face of the main body unscrews the screw member when the main body is rotated to loosen the screw member. Thus, the main body is used to tighten and loosen the screw member easily and conveniently.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an engaging structure in accordance with the preferred embodiment of the present invention.

FIG. 2 is a schematic planar view of the engaging structure in accordance with the preferred embodiment of the present invention.

FIG. 3 is a top view of the engaging structure as shown in FIG. 1.

FIG. 4 is an operational view of the engaging structure as shown in FIG. 3.

FIG. 5 is another operational view of the engaging structure as shown in FIG. 3.

FIG. 6 is a top view of an engaging structure in accordance with the second preferred embodiment of the present invention.

FIG. 7 is a top view of an engaging structure in accordance with the third preferred embodiment of the present invention.

FIG. 8 is a top view of an engaging structure in accordance with the fourth preferred embodiment of the present invention.

FIG. 9 is a top view of an engaging structure in accordance with the fifth preferred embodiment of the present invention.

FIG. 10 is a top view of an engaging structure in accordance with the sixth preferred embodiment of the present invention.

### DETAILED DESCRIPTION OF THE INVENTION

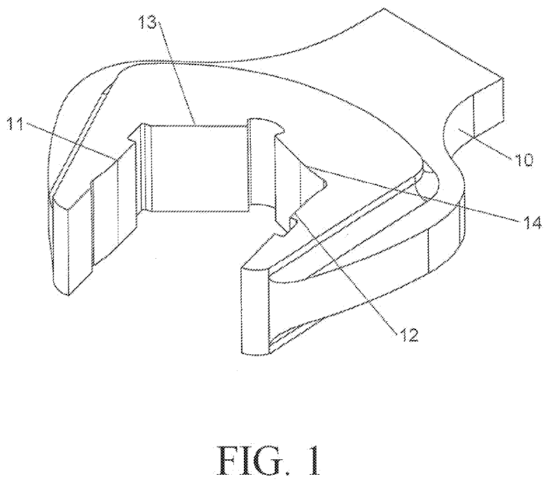

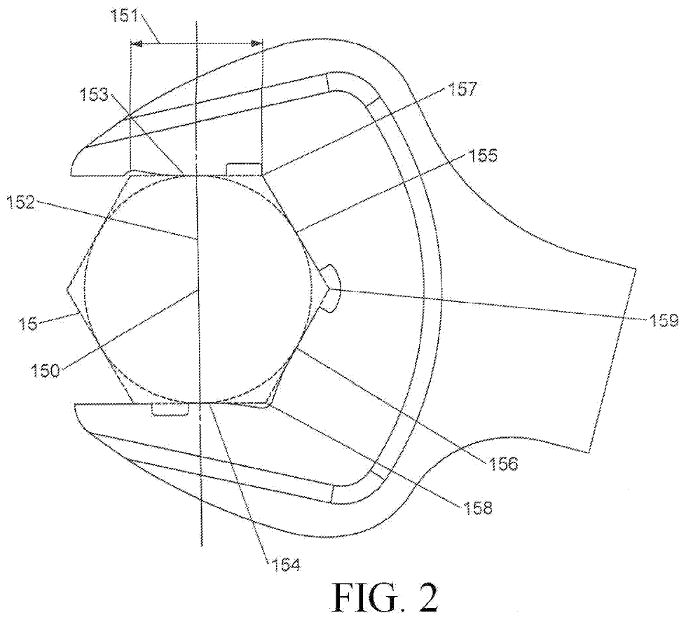

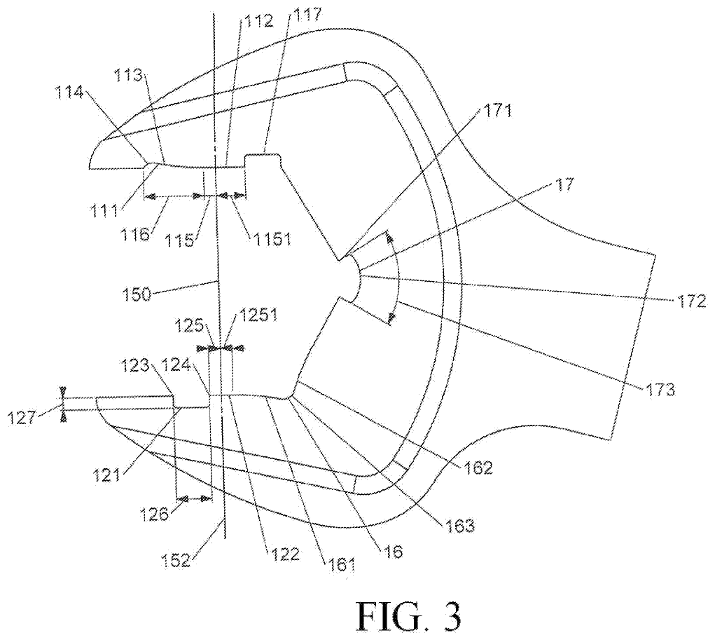

Referring to the drawings and initially to FIGS. 1-3, an engaging structure (or an operating structure or a driving structure) for a hand tool in accordance with the preferred embodiment of the present invention comprises a main body 10. The main body 10 is an open wrench or an engaging portion of a hand tool. The main body 10 includes a first side 11, a second side 12, a third side 13, and a fourth side 14. The first side 11 and the second side 12 are located opposite relative to each other. The first side 11, the third side 13, the fourth side 14, and the second side 12 are arranged serially and annularly.

The first side 11, the third side 13, the fourth side 14, and the second side 12 construct a hexagon 15 having an axis 150. The hexagon 15 has six sides each of which has a fourth length 151. A vertical line 152 passes the axis 150 in a two-dimensional plane. The hexagon 15 has a first line 153, a second line 154, a third line 155, a fourth line 156, a first angled corner 157, a second angled corner 158, and a third angled corner 159. Each of the first line 153, the second line 154, the third line 155, and the fourth line 156 has a length equal to the fourth length 151. The first line 153 aligns with the first side 11, the second line 154 aligns with the second side 12, the third line 155 aligns with the third side 13, and the fourth line 156 aligns with the fourth side 14.

The first side 11 is provided with a first recess 111 and a first face 112. The first recess 111 is situated at a left side of the vertical line 152. The vertical line 152 passes the first face 112. The first face 112 has a planar shape. The first recess 111 is provided with a first arcuate face 113 and a second arcuate face 114. The first arcuate face 113 connects the first face 112. The first arcuate face 113 is tangent to the first face 112. The first arcuate face 113 is tangent to the second arcuate face 114.

The first arcuate face 113 has a radius equal to an integer value of a distance between the first line 153 and the second line 154. Thus, if the integer value of the distance between the first line 153 and the second line 154 is 19 mm, the radius of the first arcuate face 113 is also 19 mm, and if the integer value of the distance between the first line 153 and the second line 154 is 18 mm, the radius of the first arcuate face 113 is also 18 mm. The radius of the first arcuate face 113 is more than that of the second arcuate face 114. The radius of the first arcuate face 113 is ten (10) times to twenty-five (25) times of that of the second arcuate face 114. The radius of the first arcuate face 113 is nineteen (19) times of that of the second arcuate face 114.

A first distance 115 is defined between a first end of the first face 112 and the vertical line 152. A second distance 1151 is defined between a second end of the first face 112 and the vertical line 152. The second distance 1151 is more than the first distance 115. The second distance 1151 is 2.5 times of the first distance 115. The fourth length 151 is eight (8) times to fifteen (15) times of the first distance 115. The fourth length 151 is eleven (11) times of the first distance 115. The first recess 111 has a first length 116. The first length 116 is more than the first distance 115. The first length 116 is five (5) times of the first distance 115.

The first side 11 is provided with a groove 117. The first face 112 is arranged between the first recess 111 and the groove 117. The groove 117 connects the third side 13 and has a tetragonal shape.

The second side 12 is provided with a second recess 121 and a second face 122. The second recess 121 is situated at a left side of the vertical line 152 and faces the first recess 111. The vertical line 152 passes the second face 122. The second face 122 faces the first face 112 and has a planar shape. The second recess 121 is provided with a first corner 123 and a second corner 124 at the second side 12. Each of the first corner 123 and the second corner 124 is a right angle.

A third distance 125 is defined between a first end of the second face 122 and the vertical line 152. A fourth distance 1251 is defined between a second end of the second face 122 and the vertical line 152. The fourth distance 1251 is more than or equal to the third distance 125. The third distance 125 is equal to or close to the first distance 115. The second recess 121 has a second length 126. The second recess 121 has a depth defining a third length 127. The second length 126 is three (3) times to four (4) times of the fourth distance 1251. The third length 127 is equal to the second distance 1151.

The groove 117 has a structure the same as that of the second recess 121.

A third recess 16 is defined in a connection of the second side 12 and the fourth side 14. The third recess 16 includes a third arcuate face 161, a fourth arcuate face 162, and a fifth arcuate face 163. The third arcuate face 161 and the fourth arcuate face 162 are arranged symmetrically relative to the fifth arcuate face 163. The third arcuate face 161 is tangent to the second face 122. The fourth arcuate face 162 is tangent to the fourth side 14. The third arcuate face 161, the fourth arcuate face 162, and the first arcuate face 113 have the same radian. The third arcuate face 161 has a radian equal to or close to that of the first arcuate face 113.

A fourth recess 17 is defined in a connection of the third side 13 and the fourth side 14. The fourth recess 17 includes two fifth sides 171 and a sixth arcuate face 172. The two fifth sides 171 are arranged symmetrically relative to the sixth arcuate face 172. One of the two fifth sides 171 is perpendicular to the third side 13, and the other of the two fifth sides 171 is perpendicular to the fourth side 14. An angle 173 is defined between the two fifth sides 171. The angle 173 is ranged between fifty degrees (50°) and seventy degrees) (70°). The angle 173 is sixty degrees (60°) or sixty-five degrees (65°).

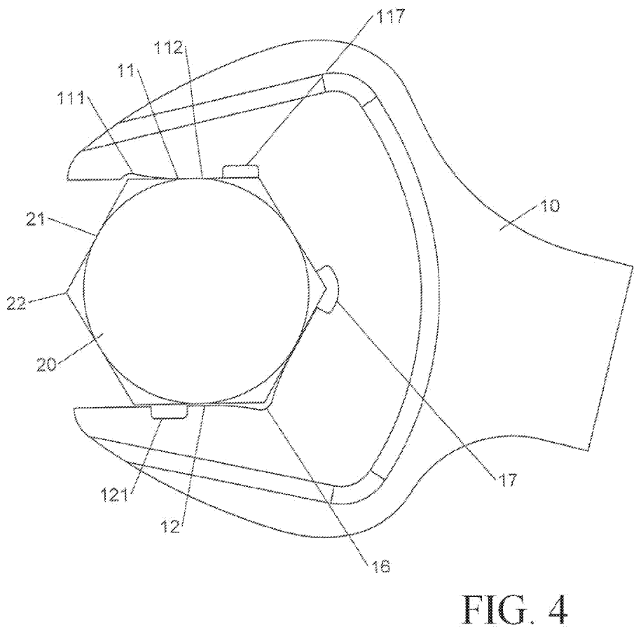

In operation, referring to FIG. 4 with reference to FIGS. 1-3, the main body 10 is used to operate a screw member 20 having six faces 21 and six sharp (or pointed) corners 22. The main body 10 is rotated clockwise to screw and tighten the screw member 20. The first face 112 of the main body 10 is the primary driving portion. When the main body 10 is rotated to drive the screw member 20, the first face 112 of the main body 10 drives and rotates one of the faces 21 of the screw member 20. The first face 112 of the main body 10 includes the first distance 115 and the second distance 1151 so that the first face 112 of the main body 10 has a rotational torque and will not cause a bite mark on the faces 21 of the screw member 20. The first recess 111, the groove 117, the fourth recess 17, and the third recess 16 of the main body 10 align with the sharp corners 22 of the screw member 20 to prevent the sharp corners 22 of the screw member 20 from being worn out.

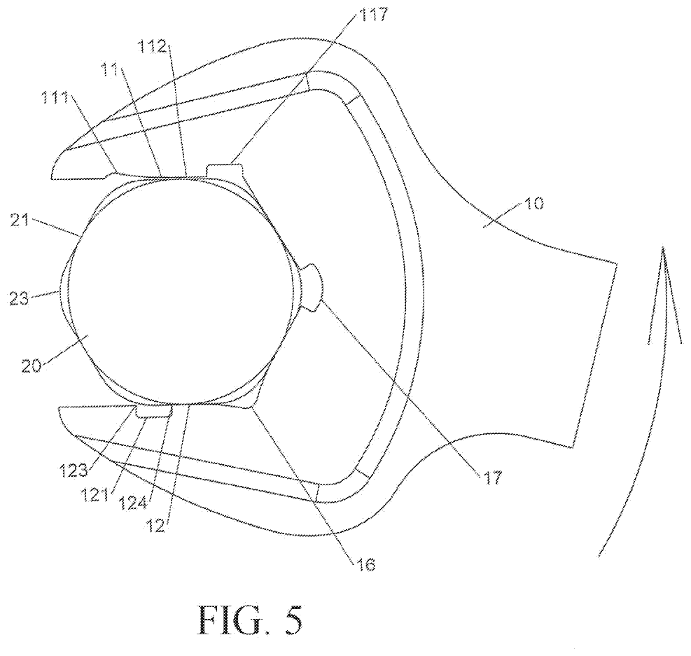

Referring to FIG. 5 with reference to FIGS. 1-3, the main body 10 is rotated counterclockwise to unscrew and loosen the screw member 20. The second recess 121 and the second face 122 of the main body 10 are the primary driving portion. Each of the sharp corners 22 of the screw member 20 may be worn into a round corner 23. When the main body 10 is rotated to drive the screw member 20, the second face 122 of the main body 10 drives and rotates one of the faces 21 of the screw member 20, and the second corner 124 of the second recess 121 engages one of the faces 21 of the screw member 20, to rotate the screw member 20. In such a manner, the second recess 121 and the second face 122 of the main body 10 cooperate to rotate the screw member 20. When the round corner 23 does not reach an excessive extent, the first corner 123 and the second corner 124 of the second recess 121 may engage one of the faces 21 of the screw member 20, to rotate the screw member 20.

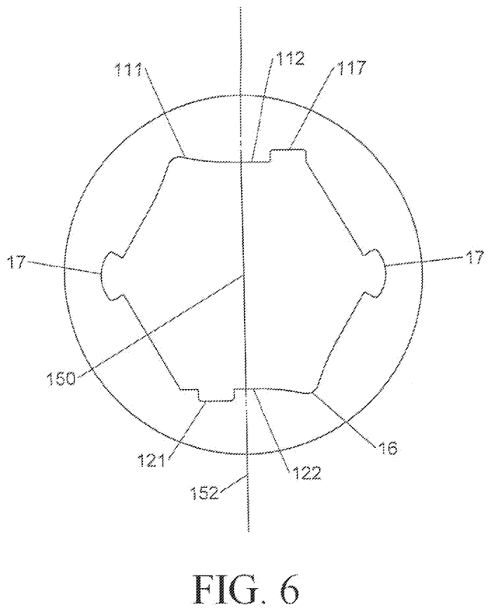

Referring to FIG. 6, the main body 10 is a socket. The main body 10 includes two fourth recesses 17. The two fourth recesses 17 are arranged symmetrically.

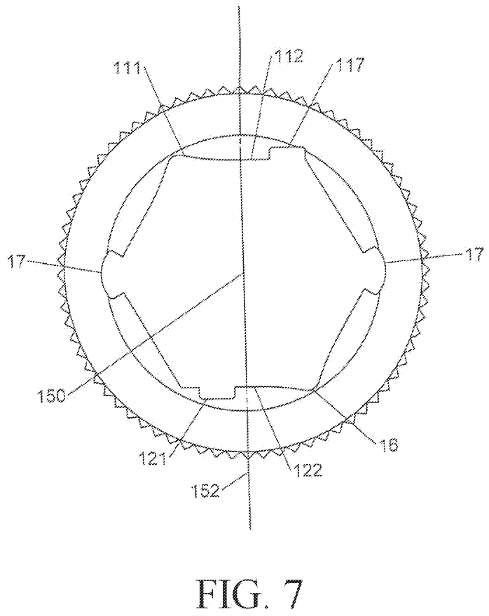

Referring to FIG. 7, the main body 10 is a ratchet wrench having multiple teeth which are arranged annularly.

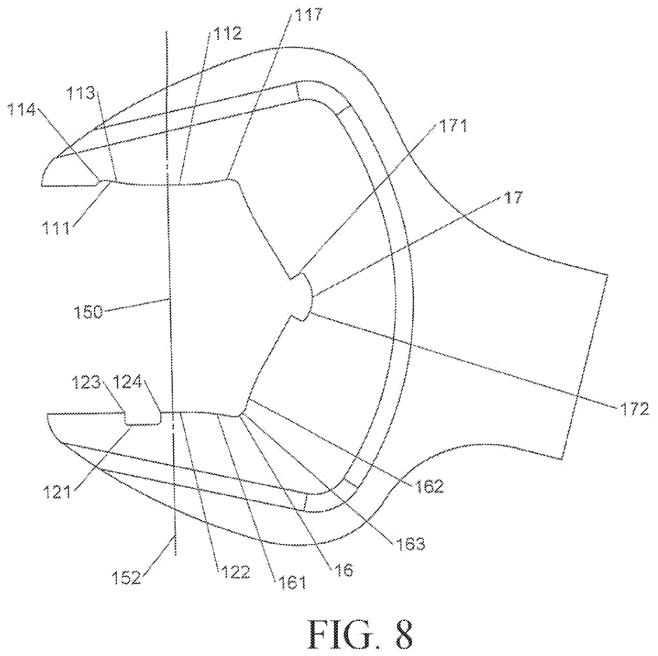

Referring to FIG. 8, the groove 117 and the third recess 16 are arranged symmetrically. The groove 117 has a structure the same as that of the third recess 16.

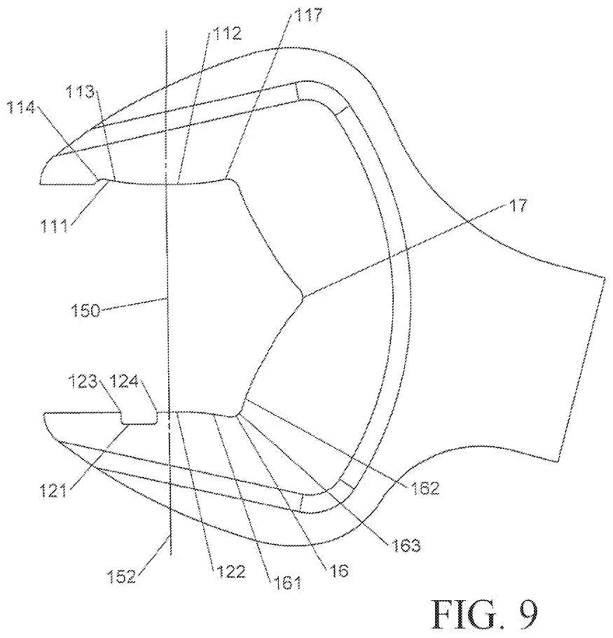

Referring to FIG. 9, the groove 117, the fourth recess 17, and the third recess 16 have the same structure.

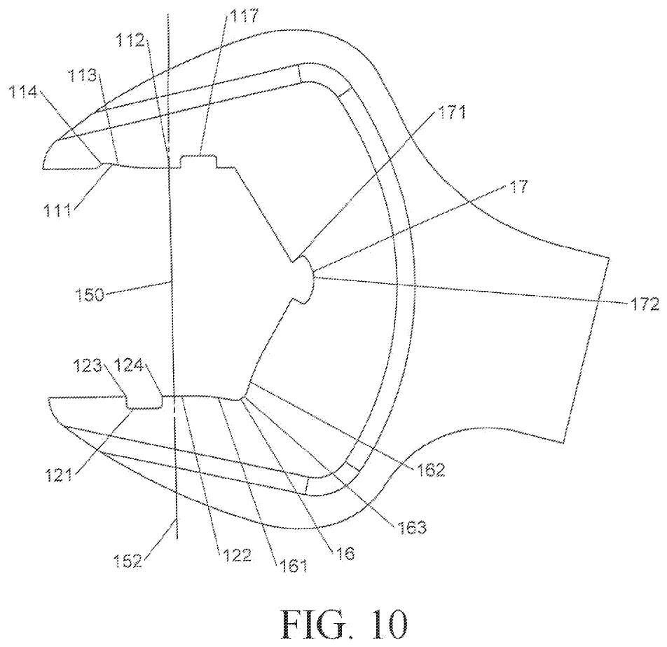

Referring to FIG. 10, the groove 117 disconnects the third side 13. The groove 117 is closer to the vertical line 152.

Accordingly, the engaging structure in accordance with the preferred embodiment of the present invention has the following advantages.
1. When the main body 10 is rotated clockwise to drive the screw member 20, the first face 112 of the main body 10 is the primary driving portion to drive and rotate one of the faces 21 of the screw member 20. The first face 112 of the main body 10 includes the first distance 115 and the second distance 1151 so that the first face 112 of the main body 10 has a larger area and provides a better rotational torque and will not cause a bite mark on the faces 21 of the screw member 20.
2. The first recess 111, the groove 117, the fourth recess 17, and the third recess 16 of the main body 10 align with the sharp corners 22 of the screw member 20 to prevent the sharp corners 22 of the screw member 20 from being worn out. Thus, when the main body 10 is rotated to drive the screw member 20, the screw member 20 will not be worn to form round corner 23.
3. When the main body 10 is rotated counterclockwise to rotate the screw member 20, the second recess 121 and the second face 122 of the main body 10 are the primary driving portion. When the second face 122 of the main body 10 drives and rotates one of the faces 21 of the screw member 20, at least the second corner 124 of the second recess 121 engages one of the faces 21 of the screw member 20, to rotate the screw member 20. In such a manner, the second recess 121 of the main body 10 provides an engaging portion to engage the screw member 20, and the second face 122 of the main body 10 provides a rotation portion to rotate the screw member 20. Thus, the second recess 121 and the second face 122 of the main body 10 cooperate to rotate and unscrew the screw member 20. When the round corner 23 of the screw member 20 does not reach an excessive extent, the first corner 123 and the second corner 124 of the second recess 121 may engage one of the faces 21 of the screw member 20, to rotate the screw member 20.
4. The main body 10 includes the first recess 111, the first face 112, the second recess 121, and the second face 122. The first recess 111 and the first face 112 of the main body 10 have a larger rotation face and provide a protection for the sharp corners 22 of the screw member 20 when the main body 10 is rotated to tighten the screw member 20. In addition, the second recess 121 of the main body 10 engages the screw member 20, and the second face 122 of the main body 10 unscrews the screw member 20 when the main body 10 is rotated to loosen the screw member 20. Thus, the main body 10 is used to tighten and loosen the screw member 20 easily and conveniently.

5. Referring to FIG. 9, the groove 117, the fourth recess 17, and the third recess 16 have the same structure. Thus, the main body 10 is similar to a conventional open wrench by provision of the groove 117, the fourth recess 17, and the third recess 16 so that the main body 10 is more acceptable by the consumer.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An engaging structure comprising:
a main body including a first side, a second side, a third side, and a fourth side;
wherein:
the first side and the second side are located opposite relative to each other;
the first side, the third side, the fourth side and the second side are arranged serially and annularly;
the first side, the third side, the fourth side, and the second side construct a hexagon having an axis;
the hexagon has six sides each of which has a fourth length;
a vertical line passes the axis in a two-dimensional plane;
the hexagon has a first line, a second line, a third line, a fourth line, a first angled corner, a second angled corner, and a third angled corner;
each of the first line, the second line, the third line, and the fourth line has a length equal to the fourth length;
the first line aligns with the first side, the second line aligns with the second side, the third line aligns with the third side, and the fourth line aligns with the fourth side;
the first side is provided with a first recess and a first face;
the first recess is situated at a left side of the vertical line;
the vertical line passes the first face;
the first face has a planar shape;
the first recess is provided with a first arcuate face and a second arcuate face;
the first arcuate face connects the first face;
the first arcuate face is tangent to the first face;
the first arcuate face is tangent to the second arcuate face;
the first arcuate face has a radius equal to an integer value of a distance between the first line and the second line;
the radius of the first arcuate face is more than that of the second arcuate face;
the radius of the first arcuate face is ten times to twenty-five times of that of the second arcuate face or the radius of the first arcuate face is nineteen times of that of the second arcuate face;
a first distance is defined between a first end of the first face and the vertical line;
a second distance is defined between a second end of the first face and the vertical line;
the second distance is more than the first distance;
the second distance is 2.5 times of the first distance;
the fourth length is eight times to fifteen times of the first distance;
the fourth length is eleven times of the first distance;
the first recess has a first length;
the first length is more than the first distance or the first length is five times of the first distance;
the second side is provided with a second recess and a second face;
the second recess is situated at a left side of the vertical line and faces the first recess;
the vertical line passes the second face;
the second face faces the first face and has a planar shape;
the second recess is provided with a first corner and a second corner at the second side;
a third distance is defined between a first end of the second face and the vertical line;
a fourth distance is defined between a second end of the second face and the vertical line;
the fourth distance is more than or equal to the third distance;
the third distance is equal to or close to the first distance;
the second recess has a second length;
the second recess has a depth defining a third length;
the second length is three times to four times of the fourth distance; and
the third length is equal to the second distance.

2. The engaging structure as claimed in claim 1, wherein the main body is an open wrench or an engaging portion of a hand tool.

3. The engaging structure as claimed in claim 1, wherein:
the first side is provided with a groove;
the first face is arranged between the first recess and the groove;
a third recess is defined in a connection of the second side and the fourth side; and
a fourth recess is defined in a connection of the third side and the fourth side.

4. The engaging structure as claimed in claim 1, wherein each of the first corner and the second corner is a right angle.

5. The engaging structure as claimed in claim 3, wherein:
the groove connects the third side and has a tetragonal shape;
the groove has a structure the same as that of the second recess;
the groove disconnects the third side; and
the groove is closer to the vertical line.

6. The engaging structure as claimed in claim 3, wherein:
the third recess includes a third arcuate face, a fourth arcuate face, and a fifth arcuate face;
the third arcuate face and the fourth arcuate face are arranged symmetrically relative to the fifth arcuate face;
the third arcuate face is tangent to the second face;
the fourth arcuate face is tangent to the fourth side;
the third arcuate face, the fourth arcuate face, and the first arcuate face have the same radian; and
the third arcuate face has a radian equal to or close to that of the first arcuate face.

7. The engaging structure as claimed in claim 3, wherein:
the fourth recess includes two fifth sides and a sixth arcuate face;
the two fifth sides are arranged symmetrically relative to the sixth arcuate face;
one of the two fifth sides is perpendicular to the third side, and the other of the two fifth sides is perpendicular to the fourth side;
an angle is defined between the two fifth sides;
the angle is ranged between fifty degrees and seventy degrees; or the angle is sixty degrees or sixty-five degrees.

8. The engaging structure as claimed in claim 1, wherein the main body is a socket including two fourth recesses that are arranged symmetrically or the main body is a ratchet wrench having multiple teeth which are arranged annularly.

9. The engaging structure as claimed in claim 3, wherein the groove and the third recess are arranged symmetrically, and the groove has a structure the same as that of the third recess or the groove, the fourth recess, and the third recess have the same structure.
